(19) United States
(12) Patent Application Publication
(10) Pub. No.: US 2007/0058294 A1
(43) Pub. Date: Mar. 15, 2007

(54) Soft magnetic film, recording head using the same, method of manufacturing soft magnetic film, and method of manufacturing recording head

(75) Inventor: Mitsuhiro Gotoh, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/517,672

(22) Filed: Sep. 8, 2006

(30) Foreign Application Priority Data
Sep. 15, 2005 (JP) 2005-268153
Aug. 11, 2006 (JP) 2006-219161

(51) Int. Cl. G11B 5/147

(52) U.S. Cl. 360/126

(57) ABSTRACT

A soft magnetic film is provided. The soft magnetic film includes a saturated magnetic flux density of at least 2.39 T, in which only N and O are added as impurity elements to a CoFe plating film. A magnetic recording head is also provided. The recording head comprising a lower core layer, an upper core layer, and a magnetic pole portion which is disposed between the lower core layer and the upper core layer to restrict a track width on a surface that faces a recording medium.

This patent document claims the benefit of Japanese Patent Application No. 2005-268153 filed on Sep. 15, 2005, which is hereby incorporated by reference.

### BACKGROUND

### Technical Field

The present embodiments relate to a soft magnetic film suitable for use in a magnetic pole portion of a recording head. Related Art

Generally, a magnetic material having a high saturated magnetic flux density Bs is used for a core layer of a thin film magnetic head. Accordingly, it is necessary to improve a record density by concentrating a magnetic flux in the vicinity of a gap of the core layer. For example, especially with an increase in recording density.

A soft magnetic film made of an alloy including Co and Fe as the magnetic material has been previously used. The soft magnetic film including Co and Fe and its manufacturing method are described in U.S. Unexamined Patent Application Publication No. 2003/0209295 [Patent Document 1].

Patent Document 1 teaches that acetic acid and boric acid are added into a plating bath when the soft magnetic film is formed so as to increase a saturated magnetic flux density of the soft magnetic film including Co and Fe.

However, when the acetic acid is added to the plating bath, a plating formation rate is substantially reduced. This is because the acetic acid is apt to form a complex with Co or Fe. Therefore, in order to increase the plating formation rate, it is necessary to greatly increase a density of Co ion or Fe ion in the plating bath. When the density of Co ion or Fe ion is increased, it expedites a degradation of plating facilities such as a filter or a plating tank used for circulating and filtering the plating bath, and it gives rise to a necessity of frequent facility substitution. Therefore, the manufacturing efficiency is decreased and the plating bath is degraded by creating a pause in circulation of the plating bath due to the frequent facility substitution or introducing dust at the time of substituting facilities.

Since the volatility of the acetic acid is large and a temporal change of density in the plating bath is large, the stability of the plating bath is decreased, which is not desired in view of working environments.

### SUMMARY

According to one exemplary embodiment, there is provided a soft magnetic film having a saturated magnetic flux density Bs of 2.39 T or more, in which only N and O are added as impurity elements to a CoFe plating film.

In this embodiment, the composition ratio of N may be in the range of about 0 at % to 4.2 at % when the total composition ratio of Co, Fe, N, and O is 100 at %.

The composition ratio of O may be in the range of about 0 at % to 10.8 at % when the total composition ratio of Co, Fe, N, and O is 100 at %.

According to another exemplary embodiment, there is provided a soft magnetic film, in which only N and O are added as impurity elements to a CoFe plating film, the composition ratio of N is in the range of about 0 at % to 4.2 at %, and the composition ratio of O is in the range of about 0 at % to 10.8 at %, when the total composition ratio of Co, Fe, N, and O is 100%.

The average crystal grain diameter may be about 0.1 μm or less. The composition ratio of Fe may be in the range of about 65.5 wt % to 74 wt % when the total composition ratio of Co and Fe is 100 at %.

In this embodiment, the composition ratio of Fe may be in the range of about 66 wt % to 73 wt %.

According to another embodiment, a recording head of an longitudinal magnetic recording type includes a lower core layer, an upper core layer, and a magnetic pole portion which is disposed between the lower core layer and the upper core layer to restrict a track width Tw on a surface facing a recording medium. The magnetic pole portion includes a lower magnetic pole layer connected to the lower core layer. An upper magnetic layer is connected to the upper core layer. A gap layer is located between the lower magnetic pole layer and the upper magnetic pole layer. The magnetic pole layer includes an upper magnetic pole layer connected to the upper core layer and a gap layer located between the upper magnetic pole layer and the lower core layer. The upper magnetic pole layer, the lower magnetic pole layer, or the upper magnetic pole layer and the lower magnetic pole layer are plated with the soft magnetic film.

Alternatively, according to another embodiment, there is provided a recording head of a perpendicular magnetic recording type, the recording head including a main magnetic pole layer. A track width Tw is restricted by a surface of the main magnetic pole layer that faces a recording medium and the main magnetic pole layer is plated with the soft magnetic film described above.

In the embodiment, the upper magnetic pole layer, the lower magnetic pole layer, and the main magnetic pole layer, which are plated with the soft magnetic film have a high saturate magnetic flux density Bs and have a fine crystal structure in which the soft magnetic film has an average crystal grain diameter is about 0.1 μm or less. Accordingly, it is possible to embody the recording head having high recording characteristic and excellent stability by planarizing the surfaces of the upper magnetic pole layer, the lower magnetic pole layer, and the main magnetic pole layer with high accuracy.

The track width Tw may be in the range of about 0.05 to 0.5 μm, the thickness of the upper magnetic pole layer may be in the range of about 0.1 to 5.0 μm. The thickness of the lower magnetic pole layer may be in the range of about 0.1 to 5.0 μm, and the lower magnetic pole layer, the upper magnetic pole layer, or the upper magnetic pole layer and the lower magnetic pole layer may have a plurality of crystals, in any portion of the track width Tw, as viewed in the thickness direction.

The track width Tw may be in the range of about 0.1 to 1.0 μm. The thickness of the main magnetic pole layer may be in the range of about 0.1 to 2.0 μm. The main magnetic pole layer may have a plurality of crystals in any portion of the track width Tw as viewed in the thickness direction.

A plurality of crystals may exist on any portion in the thickness direction as viewed in the track width Tw direction. Accordingly, the entire area of the upper magnetic pole layer, the lower magnetic pole layer, and the main magnetic pole layer, which are narrowed, can be formed dense with the fine crystals.

According to another embodiment, there is provided a method of manufacturing a soft magnetic film, wherein only N and O are added as impurity elements to a CoFe plating film by using a plating bath including only an aqueous solution of Fe salts, an aqueous solution of Co salts, sodium benzenesulfonate, and L-glutamic acid.

In this embodiment, sodium benzenesulfonate and L-glutamic acid are added to a plating bath. A plating bath can have an excellent stability since a temporal change of a plating bath composition can be reduced and a pH change of a plating bath can be suppressed without adding an acetic acid, boric acid and sodium chloride to a plating bath as in the past. Since only N and O are added as impurity elements to CoFe plating bath by the plating bath, a soft magnetic film with a saturated magnetic flux density Bs of 2.39 T or more can be efficiently plated.

The sodium benzenesulfonate added to the plating bath may be in the range of about 0.01 g/l to 0.10 g/l. The L-glutamic acid added to the plating bath may be in the range of about 0.1 g/l to 0.5 g/l.

According to another embodiment, a recording head of an longitudinal magnetic recording type comprises a lower core layer, an upper core layer, and a magnetic pole portion which is disposed between the lower core layer and the upper core layer to restrict a track width Tw on a surface facing a recording medium. The magnetic pole portion is formed of a lower magnetic pole layer connected to the lower core layer. An upper magnetic layer is connected to the upper core layer and a gap layer is located between the lower magnetic pole layer and the upper magnetic pole layer, or the magnetic pole layer formed of an upper magnetic pole layer connected to the upper core layer. A gap layer is located between the upper magnetic pole layer and the lower core layer. The upper magnetic pole layer, the lower magnetic pole layer, or the upper magnetic pole layer and the lower magnetic pole layer are plated with the soft magnetic film.

In plating the magnetic pole portion, a frame having a narrow space for plating the magnetic pole portion may be formed on the facing surface and in the narrow space, the track width Tw may be restricted to the range of about 0.05 to 0.5 μm, the thickness of the upper magnetic pole layer may be restricted to the range of about 0.1 to 5.0 μm, and the thickness of the lower magnetic pole layer may be restricted to the range of about 0.1 to 5.0 μm. The upper magnetic pole layer, the lower magnetic pole layer, or the upper magnetic pole layer and the lower magnetic pole layer may be plated in the narrow space using the plating bath, in which a plurality of crystals having a fine crystal structure with an average crystal grain diameter of about 1 μm or less exist in any portion of the track width Tw as viewed in the width direction.

According to another embodiment, there is provided a method of manufacturing a recording head of a perpendicular magnetic recording type, the recording head includes a main magnetic pole layer restricting a track width Tw to a surface facing a recording medium, wherein the main magnetic pole layer is plated with a soft magnetic film by using the above-mentioned method. When plating the main magnetic pole layer, a frame having a narrow space for plating the main magnetic pole layer may be formed on the facing surface and in the narrow space, the track width Tw may be restricted to the range of about 0.1 to 1.0 μm, and the thickness of the main magnetic pole layer may be restricted to the range of about 0.1 to 2.0 μm. The main magnetic pole layer may be plated in the narrow space using the plating bath, in which a plurality of crystals having a fine crystal structure with an average crystal grain diameter of about 1 μm or less exist in any portion of the track width Tw as viewed in the width direction.

The lower magnetic pole layer, the upper magnetic pole layer, or the main magnetic pole layer, which is plated with the soft magnetic film, may have a plurality of crystals in any portion in the thickness direction as viewed in the track width Tw direction.

The plating bath composition can be used to minutely form a soft magnetic film with a saturated magnetic flux density Bs of 2.39 T or more, in which only N and O are added as impurity elements to a CoFe plating film, even in the narrow space using fine crystals.

In the soft magnetic film according to the present embodiments, since impurities such as C, S, Cl, and B are not contained in the film, the saturated magnetic flux density Bs can be increased, and specifically it is possible to make the saturated magnetic flux density Bs of 2.39 or more. It can be formed as a fine crystal structure with an average crystal grain diameter of about 0.1 μm or less.

In the manufacturing method of a soft magnetic film according to the present embodiments, it is easy to uniformalize a crystallinity of a plated film, since a temporal change can be reduced compared to an known plating bath to which the acetic acid and the boric acid added, and it is possible to improve a stability of a pH of a plating bath compared to the known plating bath from also having a value of pKa that the known plating bath did not have.

It is possible to increase a plating formation rate since an acetic acid that easily forms Co or Fe and a complex in the plating bath is not added. Since it is possible to increase a plating formation rate, it is not necessary to make densities of Co and Fe in the plating bath higher. Consequently, since it is possible to suppress a degradation of the plating facility. Therefore, as a maintenance frequency can be greatly reduced, it is possible to effectively suppress a degradation of the plating bath generated by frequent overlapping of facility along with devising an improvement of manufacturing efficiency.

Since an acetic acid which has volatility and peculiar irritating odor it not added to a plating bath, a working environment can be improved.

Since boric acid is not added to the plating bath, B is not contained in a plated soft magnetic film. In the thin film magnetic head and the method of manufacturing the same, a thin film magnetic head with a high recording characteristic and an excellent stability can be realized since only N and O are added as impurity elements to a CoFe plating film in a narrow space which is an area of forming an upper magnetic layer or a main magnetic layer, and a soft magnetic film with a saturated magnetic flux density Bs of 2.39 T or more can be minutely formed in a fine crystal.

### BRIEF DESCRIPTION OF THE DRAWINGS

FIG. 1 is a partial front view showing a thin film magnetic head of the first embodiment.

FIG. 2 is a longitudinal sectional view of FIG. 1.

FIG. 3 is a partial front view illustrating the thin film magnetic head of the second embodiment.

FIG. 4 is a partial longitudinal sectional view illustrating the thin film magnetic head of the third embodiment.

FIG. 5 is a front view illustrating the magnetic head shown in FIG. 4.

FIG. 6 is a partial plain view illustrating the magnetic head shown in FIG. 4.

FIG. 7 is a table showing pKas of L-glutamic acid, acetic acid and boric acid.

FIG. 8 is a result of measuring the types and composition ratios of the elements added to the film of the soft magnetic film of the examples and comparative examples.

FIG. 9 is a graph showing a relation between Fe quantity and the saturated magnetic flux density Bs in the soft magnetic film of the present embodiment.

FIG. 10 is a table showing Fe density of a plating bath, Fe composition and a saturated magnetic flux density Bs of a soft magnetic film.

FIG. 11 is a table showing relations between each addition quantity of L-glutamic acid and sodium benzene-sulfonic acid added to the plating bath used for the manufacturing method of the present embodiment and saturated magnetic flux densities Bs.

FIG. 12 is a table showing a result of measuring the saturated magnetic flux density Bs of the soft magnetic film formed in the plating bath used for the existing manufacturing method.

FIG. 13 is a table showing a result of measuring the saturated magnetic flux density Bs of the soft magnetic film formed at the plating bath used for the manufacturing method of the present embodiment.

FIG. 14 is a table showing the saturated magnetic flux density Bs of the soft magnetic film formed in the plating bath with no boric acid added, with regard to a bath organization of the plating bath used for the existing manufacturing method.

FIG. 15 is a table showing the saturated magnetic flux density Bs of the soft magnetic film formed at the plating bath plating bath with boric acid added used for the manufacturing method of the present embodiment.

FIG. 16 is a table showing the saturated magnetic flux density Bs of the soft magnetic film formed at the plating bath plating bath with sodium chloride added used for the manufacturing method of the present embodiment.

FIG. 17 is an SIM image when observing a surface condition of a soft magnetic film plated from a known plating bath on a substrate of a diameter of 3 inches with a focused ion beam manufacturing observation device from a film width direction.

FIG. 18 is an SIM image when observing a surface condition of a soft magnetic film plated from the plating bath of the embodiment in a narrow space with a width of about 0.5 μm and height of 1.0 μm, at a substrate of a diameter of 3 inches with a focused ion beam manufacturing observation device from a film width direction.

FIG. 19 is an SIM image when observing a surface condition of the soft magnetic film by plating a soft magnetic film using a plating composition of the embodiment in a narrow space with a width of about 0.5 μm and height of 1.0 μm. FIG. 19B is a schematic view of FIG. 19A.

FIG. 20 is an SIM image when observing a surface condition of the soft magnetic film by plating a soft magnetic film using a plating composition of the embodiment in a narrow space with a width of about 0.5 μm and height of 1.0 μm. FIG. 20B is a schematic view of Fig. 20A.

FIG. 21 is table of the diameters and the average value of 10 crystal grains shown on a SIM image surface of each soft magnetic film of FIG. 19 and FIG. 20.

### DETAILED DESCRIPTION

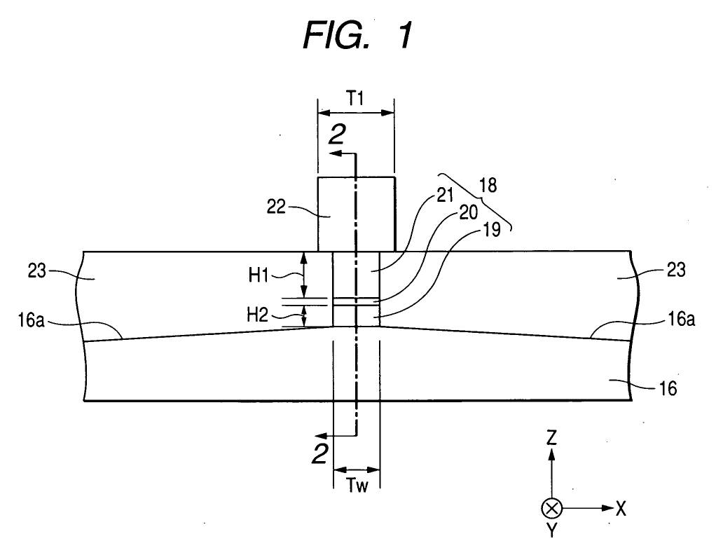

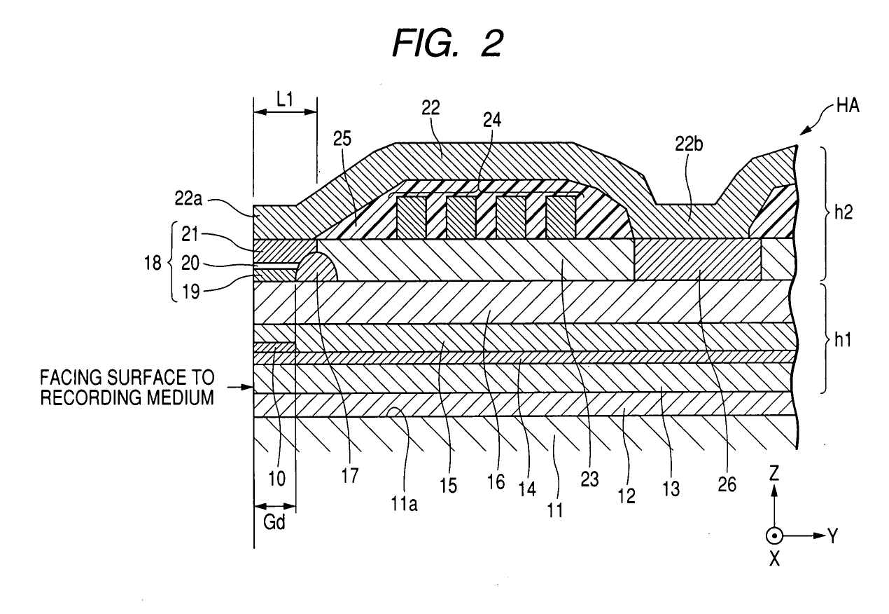

FIG. 1 is a partial front view of a thin film magnetic head of a first embodiment. FIG. 2 is a longitudinal sectional view of the thin magnetic head shown in FIG. 1 viewed from an arrow direction taken along line 2-2.

The thin film magnetic heads of FIG. 1 and FIG. 2 are formed on the trailing side edge 11a of a slider 11 of a ceramic material constituting a floating head and constituted an MR/inductive complex type thin film magnetic head (hereinafter, briefly referred to as the thin film magnetic head HA) where an MR head hi and a recording inductive head h2 are laminated.

MR head hi reads a recorded signal by detecting a leaking magnetic field from a recording medium such as a hard disk, using a magnetic resistance effect.

As shown is FIG. 2, a lower shield layer 13 made of NiFe, etc. on a trailing side edge 11a of the slider 11 is formed by interposing an Al₂O₃ film, and a lower gap layer 14 made of an insulating material is formed thereon.

Magnetoresistance effect element 10 for example, an aeolotropic magnetoresistance effect (AMR) element, a gigantic magnetoresistance effect (GMR) element and a tunnel type magnetoresistance effect (TMR) element are formed on the lower gap layer 14 in a height direction (Y direction shown in figure) from a surface facing the recording medium, and an upper gap layer 15 of the insulating material is formed on the magnetoresistance effect element 10 and the lower gap layer 14. Moreover on the upper gap layer 15, an upper shield layer 16 formed of a magnetic material such as NiFe is formed. MR head h is constituted by a film stack of from the lower shield layer 13 to the upper shield layer 16.

The upper shield layer 16 also serves as a lower core layer of the recording head h2, a Gd deciding layer 17 is formed on the lower core layer 16. A gap depth (Gd) is restricted by a length size of the surface that faces the recording medium to a front end portion of the Gd deciding layer 17. The Gd deciding layer 17 is formed of, for example, an organic insulating material.

As shown in FIG. 1, an upper surface 16a of the lower core layer 16 is formed of an inclined surface inclined in a lower surface direction as it is pulled off toward a track width direction (X direction shown) from a rear anchor of a magnetic pole portion 18 described below, thereby suppresses an occurrence of a side fringing.

As shown in FIG. 2, a magnetic pole portion 18 is formed from the surface facing the recording medium through the Gd deciding layer 17.

In the magnetic pole portion 18, a lower magnetic pole layer 19, a nonmagnetic gap layer 20 and an upper magnetic layer 21 are laminated from a bottom.

The lower magnetic layer 19 is directly plated on the lower core layer 16. It is preferable to form a gap layer 20 formed on the lower magnetic layer with nonmagnetic metallic materials that can be plated. Specifically, it is preferable to select at least one of NiP, NiPd, NiW, NiMo, Au, Pt, Rh, Pd, Ru and Cr.

The NiP is preferably used on the gap layer 20. Because the gap layer 20 can adequately become a nonmagnetic condition by forming the gap layer 20 with NiP.

An upper magnetic pole layer 21 formed on the gap layer 20 is magnetically connected with an upper core layer 22 formed thereon.

As described above, when the gap layer 20 is formed of a nonmagnetic metallic material which can be plated as above, it is possible to plate the lower magnetic pole layer 19, the gap layer 20 and the upper magnetic pole layer 21 in a row.

The magnetic pole portion 18 may be formed of two layers of the gap layer 20 and the upper magnetic pole layer 21.

As shown in FIG. 1, the magnetic pole portion 18 is formed in a track width Tw which is a width size in a track width direction (X direction shown).

As shown in FIG. 1 and FIG. 2, an insulating layer 23 is formed on both sides of the track width direction (X direction shown) of the magnetic pole portion 18 and a rear of the height direction (Y direction shown). An upper surface of the insulating layer 23 is on the same plane as an upper surface of the magnetic pole portion 18. As shown in FIG. 2, a coil layer 24 is spirally formed on the insulating layer 23. A surface of the coil layer 24 is covered by an insulating layer 25 of the organic insulating material.

As shown in FIG. 2, the upper core layer 22 is patterned, for example, from the surface of the magnetic pole portion 18 through a surface of the insulating layer 25 by a frame plating method. As shown in FIG. 1, in a front end portion 22a of the upper core layer 22, a width size in a track width direction on a surface facing a recording medium is formed in T1, and a width size T1 related thereto is formed larger than the track width Tw.

As shown in FIG. 2, a rear anchor portion 22b of the upper core layer 22b is connected directly to a connection layer 26a (back gap layer) of a magnetic material formed on the lower core layer 16.

In the thin film magnetic head HA shown in FIG. 1 and FIG. 2, the upper magnetic pole layer 21 and/or the lower magnetic pole layer 19 (hereinafter referred to as “magnetic pole layers 19 and 21”) are/is plated by a soft magnetic film with a saturated magnetic flux density Bs of 2.39 T or more since only N and O are added as impurity elements to a CoFe plating film.

Although a pure CoFe plating film made of only Co and Fe is formed, impurities are infused though it is a small quantity. A magnetic characteristic represented by a saturated magnetic flux density Bs is affected by a type of impurity elements as well as an additional amount of impurity elements.

In this exemplary embodiment, only elements of N and O are added as impurity elements in CoFe plating film as described above.

The magnetic pole layers 19 and 21 are plated by using a plating bath formed of an aqueous solution of Co salts, an aqueous solution of Fe salts, sodium benzene-sulfonic acid and L-glutamic acid, and can increase a saturated magnetic flux density Bs by 2.39 or more since the magnetic pole layer 19 and 21 can plate a CoFe plating bath to which only the elements of N and O are added as impurity elements.

Since a saturated magnetic flux density Bs of a bulk material formed of CoFe alloy is approximately 2.4 T, it has been realized that the saturated magnetic flux densities Bs of the magnetic pole layers 19 and 21 can be the saturated magnetic flux density Bs which are quite close to the bulk material.

The saturated magnetic flux densities Bs of the magnetic pole layers 19 and 20 can be composed higher than 2.39 since impurities such as C, S, Cl, and B are not added to the film of the soft magnetic film formed of the plating bath. If each of the above elements is added to the soft magnetic film, the saturated magnetic flux density Bs are reduced. However, as the magnetic pole layers 19 and 21 are formed on a soft magnetic film which does not contain each of the above elements, a reduction of the saturated magnetic flux density Bs is suppressed to increase the saturated magnetic flux density Bs.

In the magnetic pole layers 19 and 21, the composition ratio of N is in the range of 0 at % to 4.2 at % when a summation of the composition ratios of Co, Fe, N, and O is 100 at %. At the magnetic pole layers 19 and 21, the composition ratio of O is in the range of 0 at % to 10.8 at % when a summation of the composition ratios of Co, Fe, N, and O is 100 at %. If the composition ratios of the N and O as the impurity elements are within the range, as described below, it has been realized that the saturated magnetic flux density Bs can be greatly increased up to 2.45 T to the maximum.

In the magnetic pole layers 19 and 21, the composition ratio of Fe is in the range of about 65.5 wt % to 74 wt % when a summation of the composition ratios of Co and Fe is 100 at %. If the composition ratio of Fe is in the range, as described below, it has been realized that the saturated magnetic flux density Bs of the magnetic pole layers 19 and 21 can be increased up to 2.40 T or more.

At the magnetic pole layers 19 and 21, it is more preferable that the composition ratio of Fe is from about 66 wt % to 73 wt %. If the composition ratio of Fe is in the range, it has been realized that the saturated magnetic flux densities Bs of the magnetic pole layers 19 and 21 can be increased up to 2.42 T or more. In the thin film magnetic head HA, it is possible to improve the recording since it is possible to increase the saturated magnetic flux densities Bs of the magnetic pole layers 19 and 21.

A soft magnetic film to which only N and O are added as impurity elements to a CoFe plating film has a film structure suitable for a soft magnetic film plated in a very narrow space, for example, as an upper magnetic pole layer 21 or a lower magnetic pole layer 19.

A track width Tw shown in FIG. 1 is formed in the range of about 0.05 to 0.5 μm. A thickness H1 of the upper magnetic pole layer is formed in the range of about 0.1 to 5.0 μm and a maximum depth size L1 of the upper magnetic pole layer 21 (a length size in Y direction shown) is formed in the range of about 1.5 to 3.5 μm. A thickness H2 of the lower magnetic pole layer is formed in the range of about 0.1 to 5.0 μm, and a gap depth Gd which is almost the same as a depth size (a length size in Y direction shown) is formed in the range of about 0.5 to 2.5 μm. A thickness of the gap layer 20 is formed in the range of about 0.05 to 0.15 μm.

A soft magnetic film to which only N and O are added as impurity elements to a CoFe plating film of the embodiment is formed by a micro crystal structure with an average crystal grain diameter of about 0.1 μm or less. The lowest limit of the average crystal grain diameter is about 0.01 μm.

Since the whole area of the magnetic pole layer 19 and 21 can be formed of a fine crystal structure, by the soft magnetic film being plated as an upper magnetic pole layer 21 or a lower magnetic pole layer 19, it becomes a film structure with a plurality of crystal as viewed in the thickness direction (Z direction shown) whichever part it is on at least a track width Tw. It is more preferable to be a film structure with a plurality of crystal as viewed in the track width direction Tw whichever part it is on a thickness direction.

Accordingly, the magnetic pole layers 19 and 21 can become a minute film formed of a great number of fine crystals to display a stable magnetic characteristic. A stabilization of a recording characteristic can be devised since the surfaces of the lower magnetic pole layer 19 and the upper magnetic pole layer 21 can all approach to a flattening surface and, for example, the gap layer 20 can be plated on the lower magnetic pole layer 19 that is close to a flattening surface.

The magnetic pole layers 19 and 21 can be formed as a soft magnetic film of a fine crystal structure capable of displaying a stable magnetic characteristic with a high saturated magnetic flux density Bs. Thus a recording head with an excellent recording characteristic is capable of adequately dealing with a high recording densification.

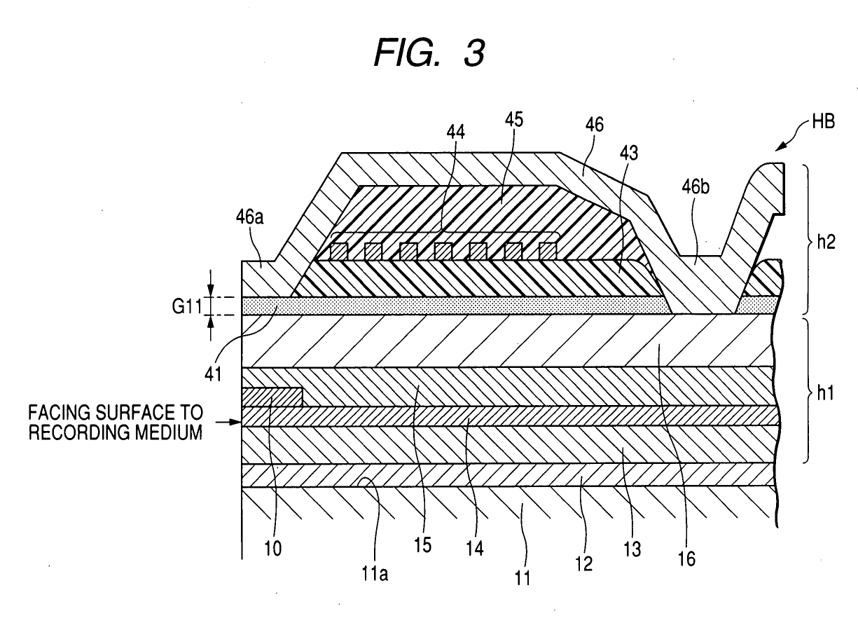

FIG. 3 is a longitudinal sectional view of a thin film magnetic head HB of a second embodiment. As shown in FIG. 3, a magnetic gap layer (nonmagnetic material layer) 41 is formed on the lower core layer 16 with alumina. Moreover a planar and spirally patterned coil layer 44 is provided on the magnetic gap layer 41 by interposing polyimide or an insulating layer 43 of a resist material. The coil layer 44 is formed of a nonmagnetic conductive material with a small electric resistance such as Cu (copper).

The coil layer 44 is surrounded by an insulating layer 45 formed of the polyimide or the resist material to form an upper core layer 46 of a soft magnetic material on the insulating layer 45.

As shown in FIG. 3, a front end portion 46a of the upper core layer 46 is facing a surface that faces the recording medium by interposing the magnetic gap layer 41 on the upper core layer 16 to form a magnetic gap of a magnetic gap length G11, and a rear anchor portion 46b of the upper core layer 46 is magnetically connected with the lower core layer 16 as shown in FIG. 3.

In the form shown in FIG. 3, a width size in a track width direction at a surface facing a recording medium of the upper core layer 46 is regulated by a track width Tw. At least the upper core layer 46 is plated as a soft magnetic film with a saturated magnetic flux density Bs of 2.39 T or more since only the elements of N and O are added as impurity materials in CoFe plating film as the magnetic layers 19 and 21, for example, as explained for FIG. 1 and FIG. 2. The upper core layer 46 can be formed as a soft magnetic film of a fine crystal structure capable of displaying a stable magnetic characteristic with a high saturated magnetic flux density Bs, as the magnetic layers 19 and 21 of the thin film magnetic head HA explained by FIG. 1 and FIG. 2. Thus a recording head includes an excellent recording characteristic capable of adequately dealing with a high recording densification.

The lower core layer 16 shown in FIG. 3 may be formed as a soft magnetic film with a saturated magnetic flux density Bs of 2.39 T or more since only N and O are added as impurity elements to a CoFe plating film as the upper core layer 46.

Although a recording head h2 in a thin film magnetic head HA and HB shown in FIGS. 1 to 3 are all of ‘longitudinal magnetic recording method’ for recording in a horizontal direction with regard to a recording medium surface, the soft magnetic film to which only N and O are added as impurity elements to a CoFe plating film can also be applied to a main magnetic pole layer of a thin film magnetic head of a perpendicular magnetic recording type shown below.

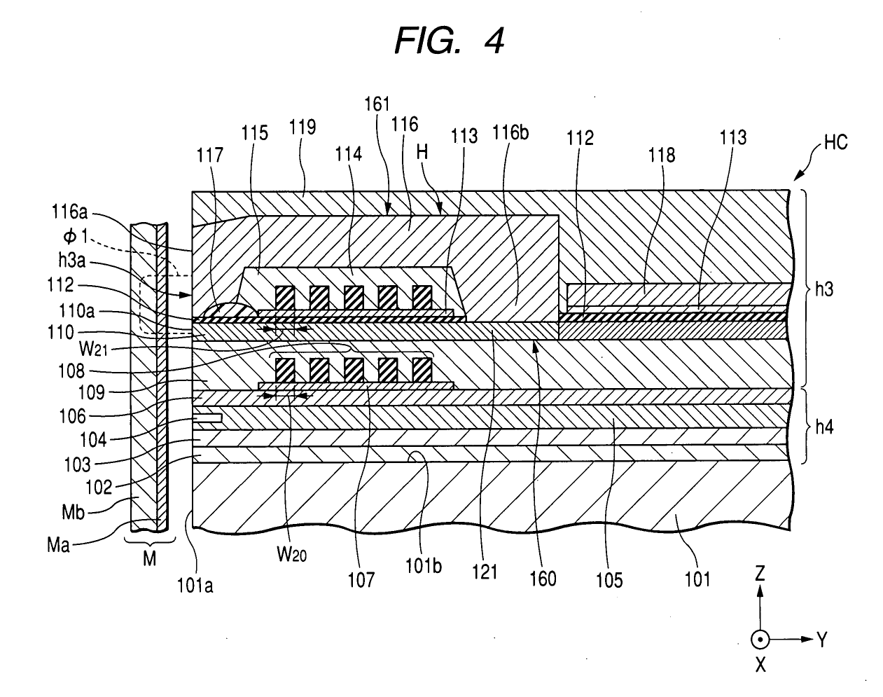

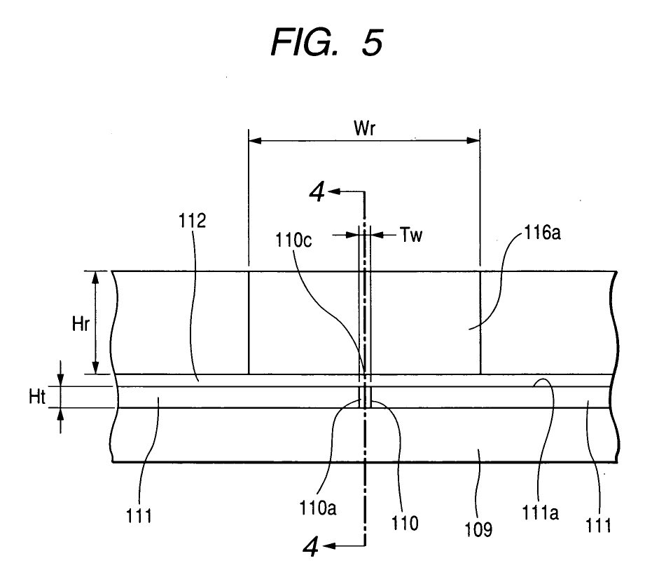

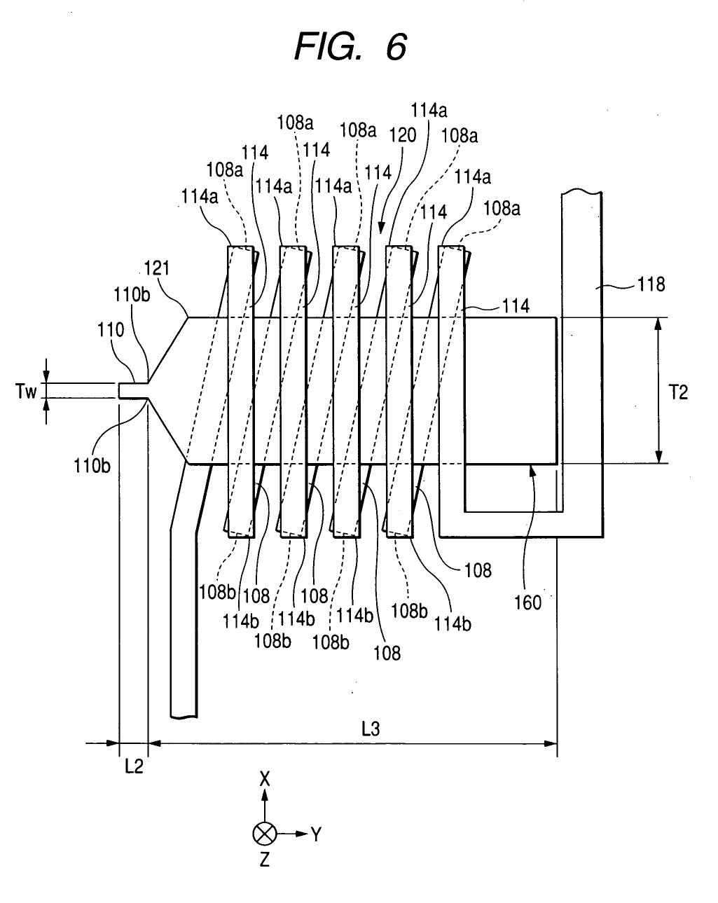

FIG. 4 is a longitudinal sectional view of thin film magnetic head HC of the third embodiment viewed from an arrow direction. The thin film magnetic head shown in FIG. 5 is cut from line 4-4. FIG. 5 is a partial front view of the thin film magnetic head, and FIG. 6 is a partial plan view indicating a main magnetic pole layer and a solenoid coil layer including the thin film magnetic head.

A magnetic head h3 constituting a thin film magnetic head HC shown in FIG. 4 is so-called a vertical recording magnetic head that magnetizes a hard film Ma of a recording medium M by granting a perpendicular magnetic field to the recording medium M.

The recording medium M has, for example, a disk shape, and a hard film Ma with a high residual magnetization on its surface and has a soft film Mb with a high magnetic transmittance therein. The recording medium M rotates with a disk center as a pivot center.

A slider 101 is formed of nonmagnetic materials such as Al₂O₃.TiC, 101a, a facing surface of 101, faces a recording medium M, and when the recording medium M rotates, the slider 101 floats from the surface of the recording medium M by the aerial flow of the surface, or the slider 101 slides on the recording medium M.

On a trailing side edge 101b of the slider 101, a nonmagnetic insulating layer 102 by bioinorganic materials such as Al₂O₃ or SiO₂ are formed. A MR head h4 is formed on this nonmagnetic insulating layer 102.

The MR head h4 has a regeneration element 104 located at a lower shield layer 103 and an upper shield layer 106, and within a bioinorganic insulating layer between the lower shield layer 103 and the upper shield layer 106 (gap insulating layer). The regeneration element 104 is a magnetoresistance effect element, for example, AMR, GMR, or TMR.

On the upper shield layer 16, a plurality of the first coil layer 103 is formed of a conductive material and is formed through a coil insulating foundation layer 107. The first coil layer 108 is made of at least one nonmagnetic material selected from, for example, Au, Ag, Pt, Cu, Cr, Al, Ti, NiP, Mo, Pd, and Rh. Alternatively, a laminated structure of which these nonmagnetic materials laminated is also permissible.

In the periphery of the first coil layer 108, a coil insulating layer 109 formed of a bioinorganic insulating material such as Al₂O₃ is formed.

An upper surface 109a of the coil insulating layer 109 is formed of a flattening surface, and on this upper surface 101a is formed a main magnetic pole layer 110, which is formed of a predefined length in a height direction from a facing surface h3a, of which a width size to a track width direction (X direction shown) is formed as track width Tw, and extended to a predefined length size L2. The main magnetic layer 110 is plated by a ferromagnetic material, and formed of a soft magnetic film with a saturated magnetic flux density Bs of 2.39 T or more since only N and O are added as impurity elements to a CoFe plating film.

A yoke part 121, which is extended since a width size T2 in a track width direction in a height direction (Y direction shown) becomes wider than the track width Tw, as it is a single body with the main magnetic pole layer 110 from a rear anchor portion 110b of the magnetic pole layer 110. The first magnetic portion 160 is made of this main magnetic pole layer 110 and the yoke portion 121 (refer to FIG. 6). However, the main magnetic layer 110 and the yoke portion 121 may be composed as a separate body. At the recording head h3 shown in FIG. 4, the first magnetic portion 160 made of the main magnetic pole layer 110 and the yoke portion 121, becomes a magnetic portion located at a MR head h4 side.

Specifically, the track width Tw is formed in the range of about 0.1 μm to 1.0 μm, and the length size L2 in the range of about 0.1 μm to 1.0 μm.

The yoke portion 121 is approximately 1 μm to 100 μm at a part where a width size of a track width direction (X direction shown) is the largest, and length size L3 in a height direction of the yoke portion 121 is approximately 1 μm to 100 μm.

As shown in FIG. 5, an insulating material layer 111 is arranged in the periphery of the main magnetic pole layer 110. A surface 110c of the main magnetic pole layer 110 and a surface 111a of the insulating material layer 111 formed in the periphery of the main magnetic pole layer 110 make a same surface. The insulating material layer 111 can be formed in at least one of, for example, Al₂O₃, SiO₂, Al—Si—O, Ti, W and Cr.

On the main magnetic pole layer 110 and the yoke portion 121 and on the insulating material layer 111, a gap layer 112 is arranged by bioinorganic material such as alumina or SiO₂.

As shown in FIG. 4, on the gap layer 112, the second coil layer 114 is formed through a coil insulating foundation layer 113. Similar to the first coil layer 108, a plurality of second coil layers are formed of a conductive material. The second coil layer 114 is formed of at least one nonmagnetic metallic material selected from, for example, Au, Ag, Pt, Cu, Cr, Al, Ti, NiP, Mo, Pd and Rh. Alternatively, it may be a lamination layer of which these nonmagnetic metallic materials are laminated.

As shown in FIG. 6, for the first coil layer 108 and the second coil layer 114, an end 108a and 114a together, and 108b and 114b together in each track width direction (X direction shown) are electrically connected, and a solenoid coil layer 120 formed by turning around an axis of the main magnetic layer 110 and the yoke portion. 121 at the first coil layer 108 and the second coil layer 114. As shown in FIG. 4, a width size W₂₀ of the height direction of the first coil layer 108 (Y direction shown) and a width size W₂₁ of the height direction of the second coil layer 114 (Y direction shown) are formed of a same size.

In the periphery of the second coil layer 114, a coil insulating layer 115 formed of a bioinorganic insulating material such as Al₂O₃ are formed, and a return pass layer 116 which is the second magnetic portion 161, is formed from the top of this coil insulating layer 115 through the gap layer 112 by a ferromagnetic material such as Permalloy.

As shown in FIG. 5, a thickness size Ht of an anterior end of the main magnetic pole layer 110 is smaller than a thickness Hr of an anterior end of the return pass layer 116, and a thickness size Tw of a track width direction of an anterior end of the main magnetic layer 110 is sufficiently shorter than a width size Wr in a same direction of an anterior end 116a or the return pass layer 116. Consequently, on a facing surface h3a, an area of an anterior end 110a of the main magnetic layer 110 is sufficiently smaller than the area of an anterior end 116a of the return pass layer 116. Therefore, a magnetic flux φ of a leaking recording magnetic field is concentrated at an anterior end 110a of the main magnetic pole layer 110, and the hard film Ma gets magnetized in a vertical direction by this concentrated magnetic flux φ to record a magnetic data.

The anterior end 116 of the return pass layer 116 is exposed on a surface facing a recording medium h3a. At a side farther from the recording medium M than the facing surface h3a, a connection portion 116b of the return pass layer and the main magnetic pole layer 110 is connected. Herewith, a magnetic path passing through the return pass layer 116 from the main magnetic pole layer 110 is formed.

On the gap layer 112 and at a location distant from a facing surface to a recording medium h3a as much as a predefined distance, a Gd deciding layer 117 is formed of a bioinorganic or an organic material. A gap depth length of the recording head h3 is defined by a distance from the surface facing a recording medium h3a to an edge of an anterior end of Gd deciding layer 117.

At a side of a height direction of the connection portion 116b of the return pass layer 116 (Y direction shown), a lead layer 118 extended from the second coil layer 114 is formed through a coil insulating foundation layer 113.

At the recording head h3, when a recording current is granted to the first coil layer 108 and the second coil layer 114 through the lead layer 118, a recording magnetic field is inducted to the main magnetic layer 110 and the return pass layer 116 by a current magnetic field that flows at the first coil layer 108 and the second coil layer 1145, and for the facing surface h3a, a magnetic flux φ1 of a recording magnetic field springs out from an anterior end 110a of the main magnetic layer 110 and the magnetic flux φ1 of the recording magnetic field transits a soft film Mb by penetrating a hard film Ma of the recording medium N, and herewith, the magnetic flux φ1 returns to the anterior end 116a of the return pass layer 116 after a recording signal is recorded on the recording medium M.

The main magnetic pole layer 110 shown in FIG. 4 is added with only N and O as impurity elements in CoFe plating film likewise the magnetic pole layers 19 and 21 explained in FIG. 1 and FIG. 2, and formed of a soft magnetic film with a saturated magnetic flux density Bs of 2.39 T or more. At this main magnetic layer 110 a saturated magnetic flux density Bs can be increased likewise the magnetic pole layers 19 and 21 of the thin film magnetic head HA shown in FIG. 1 and FIG. 2.

A soft magnetic film to which only N and O are added as impurity elements to a CoFe plating film of the embodiment is formed of a micro crystal structure with an average crystal grain diameter of about 0.1 μm or less.

The main magnetic pole layer 110 is a narrow structure formed of a track width Tw of about 0.1 to 1.0 μm, thickness size Ht of about 0.1 to 2.0 μm, length size of depth L2 of about 0.1 μm to 1.0 μm, and the soft magnetic film is plated as the narrow-structured main magnetic pole layer 110, and the whole area of the main magnetic pole layer 110 is formed of a fine crystal structure. Thus a plurality of crystals exist as viewed in the thickness direction (Z direction shown) whichever part it is in a track width Tw, and preferably becomes a film structure in which a plurality of crystals exist as viewed in a track width direction Tw whichever part it is in a thickness direction.

Accordingly, the main magnetic pole layer 110 can display a stable magnetic characteristic since it becomes a minute film formed of a large number of fine crystals. A stabilization of a recording characteristic can be devised since a surface of the main magnetic pole layer 110 can approach a flattening surface to plate the gap layer 112 on the flattened main magnetic pole layer 110.

Since the main magnetic pole layer 110 can be formed as a soft magnetic film capable of displaying a stable magnetic characteristic by a high saturated magnetic flux density Bs, a perpendicular magnetic recording head with an excellent recording characteristic is capable of appropriately coping with a high recording densification.

With regard to a recording head h3 shown in FIG. 4, a return pass layer 116 may be formed as a soft magnetic film with a saturated magnetic flux density of 2.39 T or more, since only N and O are added as impurity elements to a CoFe plating film as the main magnetic pole layer 110.

A soft magnetic film according to the embodiment with a saturated magnetic flux density of 2.39 T or more to which only N and O are added as impurity elements to a CoFe plating film, can also be used for a flat magnetic element such as an inductor.

A plating method of the magnetic pole layers 19 and 21 shown in FIG. 1 and FIG. 2 is explained below. A plating bath to which only a an aqueous solution of Co salts, an aqueous solution of Fe salts, a sodium benzene-sulfonic acid and an L-glutamic acid are added is used for the plating bath for plating the magnetic pole layers 19 and 21. The aqueous solution of Co salts and the aqueous solution of Fe salts are ionized in a water solution.

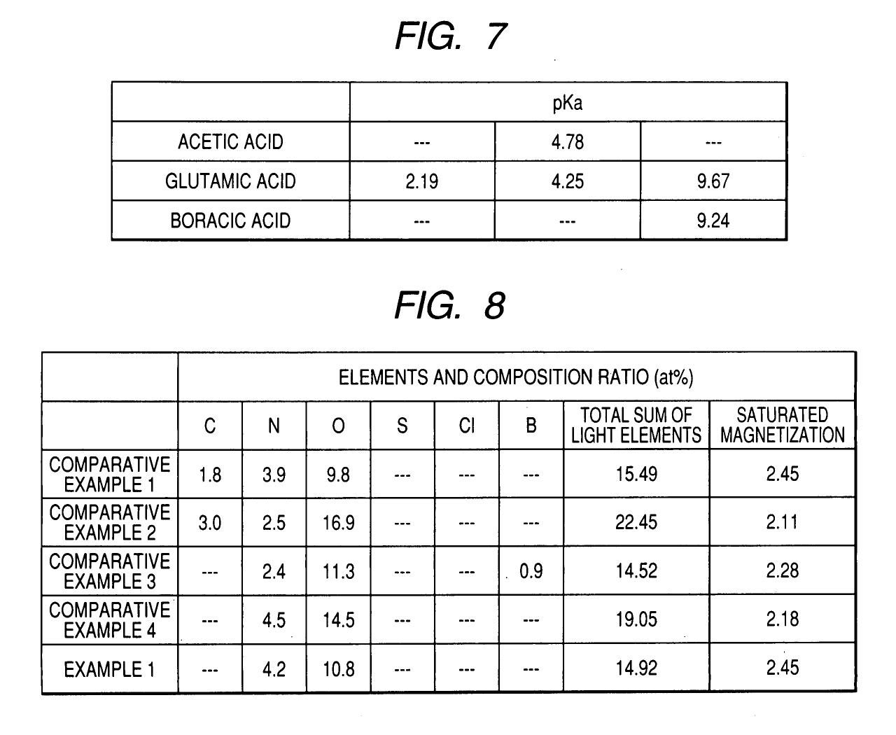

For example, CoS0₄.7H₂O is used for a water solution of the aqueous solution of Co salts. FeSO₄.7H₂O is used for a water solution of the aqueous solution of Fe salts. As sodium benzene-sulfonic acid has a function of bringing in the oxygen of the plating bath by combining with the O element in the plating bath and turning into a benzene-sulfonic acid, it can adequately suppress a content of O element of a plated soft magnetic film. As shown in FIG. 7, it is known that L-glutamic acid has three pKas of 2.19, 4.25 and 9.67.

Generally, when a pKa of a certain solution is a value of A a great quantity of acid or alkali is necessary to change the pH value of A of the solution, when the pH of the solution is A, the same value as the pKa. For example, it is known that a buffering capacity is brought out at the pH same as the value A of pKa. It is preferable that the plating bath brings out a buffering capacity thereof since it is easier to maintain the plating bath in a stable condition.

In the manufacturing method of the existing soft magnetic film described in Patent Document 1, an acetic acid and a boric acid were added to a plating bath used for this method (hereinafter referred to as ‘known plating bath’). As shown in FIG. 7, a pKa of an acetic acid is about 4.78. A pKa of the boric acid is about 9.24. For example, the known plating bath has 2 pKas of about 4.78 and about 9.24.

Correspondingly, the plating bath used for the manufacturing method of the magnetic pole layers 19 and 21 (soft magnetic film) of the present embodiment (hereinafter referred to as “the plating bath according to the present embodiment”) has three pKas of about 2.19, 4.25 and 9.67 as shown in FIG. 7. The pKas of about 4.25 and 9.67 have values very near to the values of about 4.78 and 9.24 of the known plating bath.

The two pKas of about 4.25 and 9.67 of the plating bath according to the present embodiment contribute to an improvement of a plating efficiency by mainly contributing to a stability of pH value in the vicinity of a surface pole of a plated object.

As described below, if pHs of the entire plating bath are adjusted to a value of 2.19, it is predicted that pH of a plating bath in the vicinity of a surface pole of a plated object in a plating bath will rise up to about 4.25 or close to 9.67. Therefore, a soft magnetic film with a good crystallinity can be formed since only N and o are added as impurity elements to a plating film to have a saturated magnetic flux density of 2.39 T or more by the plating bath according to the present embodiment to which L-glutamic acid is added.

The plating bath according to the present embodiment also has a pKa of about 2.19 which does not exist in the known plating bath. This pKa contributes to the stability of the pH value of the whole plating bath. Therefore, in the plating bath according to the present embodiment, in addition to guaranteeing a stability of a plating bath likewise the known plating bath to which the acetic acid and the boric acid is added, in the plating bath according to the present embodiment, it is easy to uniformalize a crystallinity of a plated film since a stability of a plating bath can be improved compared to the known plating bath to enable a suppression of a notable pH change since it has a value of about 2.19 of pKa that the known plating bath did not have.

Unlike the plating film of the prior art, an acetic acid is not added to the plating bath according to the present embodiment. Since an acetic acid is apt to form a complex with Co or Fe, a plating formation rate of a soft magnetic film formed in a plating bath including an acetic acid gets notably lower. However, a plating formation rate can be increased since an acetic acid apt to form a complex with Co or Fe is not added to the plating bath according to the present embodiment.

Since the composition ratio of Co or Fe in a soft magnetic film can be raised in the plating bath of the present embodiment as described above, it is not necessary to raise the densities of Co or Fe in the plating bath. Accordingly, for example, a degradation of plating facilities such as a filter or a plating tank used for circulating a plating bath can be suppressed. Accordingly, the maintenance, for example, a substitution of plating facilities can be greatly reduced. It is possible to effectively suppress a degradation of a plating bath due to a stoppage of a plating bath's circulation due to a frequent overlap of facility substitution, or an interfusion of wastes during facility substitution, along with devising an improvement of a manufacturing efficiency.

Due to a very high volatility of an acetic acid, a density of an acetic acid in the plating bath gets rapidly lower by a volatility of an acetic acid, therefore, a temporal change of a bath composition in the known plating bath to which the acetic acid is added is very large which results to a poor stability of the plating bath. It is not preferable for a working environment since the acetic acid, which has an irritating odor of its own, volatiles from a plating bath and makes the surrounding environment worse.

Correspondingly, an acetic acid is not added to the plating bath. Therefore, a stability of a plating bath becomes excellent, and the working environment can be adequately suppressed from getting worse at the same time since a temporal change of the bath composition of the plating bath can be reduced.

In the plating bath according to the present embodiment, it has been realized that a saturated magnetic flux density Bs of a plated soft magnetic film does not decrease even though a boric acid is not added to the plating bath.

In the plating bath according to the present embodiment, it is preferable to add the sodium benzene-sulfonic acid within the range from about 0.01 g/l to 0.05 g/l. It has been realized that if the sodium benzene-sulfonic acid is added within the range, a saturated magnetic flux density Bs can be certainly increase to 2.42 T or more as described below.

It is preferable to add the L-glutamic acid within the range from about 0.1 g/l to 0.5 g/l. It has been realized that if the L-glutamic acid is added within the range, a saturated magnetic flux density Bs can be certainly increased to 2.42 T or more as described below.

In the plating bath according to the present embodiment, it is preferable to use L-glutamic acid, since a solubility of a plating bath is very low if a D-glutamic acid which is an isomeric form or its sodium chloride is used instead of the L-glutamic acid.

For example, C₆H₄CONNaSO₂ contains impurities such as S (sulfur) which causes erosion not included in the plating bath according to the present embodiment. A compound that includes a precious metal such as Rh added to improve a corrosion resistance in the past is not added.

The magnetic pole layers 19 and 21 are plated by an electric plating method using the plating bath. Optimally, the electric plating method is that of using a pulse current.

In the electric plating method using a pulse current, a time flowing a current and a vacant time not flowing a current is arranged when plating by, for example, repeating ON/OFF of a current control element. By arranging a time of which a current is not flowing as above, it is possible to mitigate a deflection of the current density distribution when plating, compared to using a direct current as in the past, even if the magnetic layers 19 and 21 are plated by degrees and a density of Fe ion occupying the plating bath is increased.

It is preferable to make a duty ratio of the pulse current approximately 0.1 to 0.5 by, for example, repeating ON/OFF by a cycle of several seconds.

Since it is possible to mitigate a deflection of the current density distribution when plating in the electric plating method by a pulse current as above, it is possible to miniaturize the crystal of the magnetic pole layer more compared to an electric plating method by a direct current. The Fe content added to the magnetic layers 19 and 21 can be increased more than before.

In case of using the electric plating method by a pulse current, the Fe amount included in the magnetic layers 19 and 21 can be easily regulated to be suitable in the range of about 65.5 wt % to 74 wt %, preferably within 66 wt % to 73 wt %.

In order to plate a magnetic pole portion 18 shown in FIG. 1 and FIG. 2, first of all, coat a register layer (not shown in a figure) which becomes a frame to form the magnetic pole portion 18 on the lower core layer 16 to form a narrow space (removing pattern) in an area where the magnetic pole portion 18 is formed by an exposure development of the register layer. This narrow space has a track width Tw shown in FIG. 1, and a height size of the narrow space is formed of at least a summation of a height size of a lower magnetic pole layer 19, gap layer 20 and upper magnetic pole layer 21 or more.

In one exemplary embodiment, it has a saturated magnetic flux density of 2.39 T or more, in which only N and O are added as impurity elements to a CoFe plating film in the narrow space by using a plating bath formed by adding the an aqueous solution of Fe salts, an aqueous solution of Co salts, sodium benzenesulfonate, and L-glumatic acid, and plates a lower magnetic pole layer 19 and an upper magnetic pole layer 21 from a soft magnetic film with a good crystallinity.

The soft magnetic film plates and grows in a fine crystal structure with an average crystal grain diameter of about 0.1 μm or less in the narrow space, so that a plurality of crystals exist as viewed in the thickness direction whichever part it is on a track width Tw direction, and preferably, the soft magnetic film plates and grows in a film structure where a plurality of crystals exist as viewed in the track width Tw direction whichever part it is on a film width direction.

Accordingly, the lower magnetic pole layer 19 and the upper magnetic pole layer 21 are plated minutely as a fine crystal structure in a narrow space, so that a stable magnetic characteristic can be displayed and the surfaces of the lower magnetic pole layer 19 and the upper magnetic pole layer 21 can be effectively close to a flattening surface. Therefore, a recording head h2 with a stable characteristic can be suitably and easily manufactured since a gap layer 20 plated on the lower magnetic pole layer 19 can be plated on a shape with as little irregularity as possible.

A main magnetic pole layer 110 of a recording head h3 of a recording head of a perpendicular magnetic recording type can be formed by a same method as the magnetic pole layer 19 and 21.

For example, in order to plate the main magnetic pole layer 100, a register layer (not shown in a figure) which becomes a frame for forming the main magnetic pole layer 110 on the coil insulating layer 109 is coated, and a narrow space (removing pattern) in an area where the main magnetic pole layer 110 is formed by an exposure development of the register layer. This narrow space has a track width Tw shown in FIG. 5 and 6, and a height size of the narrow space is formed as at least a film width size Ht of the main magnetic pole layer 110 or more.

In this exemplary embodiment, it has a saturated magnetic flux density of 2.39 T or more, in which only N and O are added as impurity elements to a CoFe plating film in the narrow space by using a plating bath formed by adding the an aqueous solution of Fe salts, an aqueous solution of Co salts, sodium benzenesulfonate, and L-glutamic acid, and plates a main magnetic pole layer 110 from a soft magnetic film with a good crystallinity.

The soft magnetic film plates and grows in a fine crystal structure with an average crystal grain diameter of 0.1 μm or less in the narrow space, so that 2 or more crystals exist as viewed in the thickness direction whichever part it is on a track width Tw direction, and preferably, the soft magnetic film plates and grows in a film structure where 2 or more crystals exist as viewed in the track width Tw direction whichever part it is on a film width direction.

Accordingly, the main magnetic pole layer 110 is plated minutely as a fine crystal structure in a narrow space, so that a stable magnetic characteristic can be displayed and the surfaces of the main magnetic pole layer 110 can be effectively close to a flattening surface. Therefore, a recording head h3 with a stable characteristic can be suitably and easily manufactured since a gap layer 110 formed on the main magnetic pole layer 110 can be suitably plated on a shape with as little irregularity as possible.

An upper core layer 46 and a lower core layer 16 shown in FIG. 3 are also plated using a plating bath related to the embodiment. The core layer 16 and 46 are formed according to the plating method using a pulse current.

### EXAMPLE 1

FIG. 8 is a table that shows a type and composition ratio of detected ions added to the films, and a saturated magnetic flux density Bs, with regard to an example of a soft magnetic film formed by using the plating bath according to the present embodiment, and a comparative example of a soft magnetic film formed in a plating bath using the known plating bath.

Composition ratios and a current density of a plating bath that formed Example 1 according to the present embodiment are, 12.45 g/l of FeSO₄.7 H₂O, 1.431 g/l of CoSO₄.7 H₂O, 0.01 g/l of sodium benzene-sulfonic acid and 0.1 g/l of L-glutamic acid, and the current density is 30 mA/cm².

A composition and a current density of the known plating bath are as below.

The composition and the current density of the plating bath that formed in Example 1: 122.00 g/l of FeSO₄.7 H₂O, 53.00 g/l of CoSO₄.7 H₂O, 12 g/l of acetic acid, 25 g/l of boric acid and 0.50 g/l of sodium chloride, and a current density of 20 mA/cm².

A composition and a current density of a plating bath that formed Comparative Example 2: 62.95 g/l of FeSO₄.7 H₂O, 17.54 g/l of CoSO₄.7 H₂O, 3 g/l of acetic acid, 0 g/l of boric acid, and 0 g/l of sodium chloride, and a current density of 20 mA/cm².

A composition and a current density of a plating bath that formed Comparative Example 3: 8.73 g/l of FeSO₄.7 H₂O, 1.4 g/l of CoSO₄.7 H₂O, 0.01 g/l of sodium benzene-sulfonic acid, 0.1 g/l of L-glutamic acid, 25 g/l of boric acid, and 0 g/l of sodium chloride, and a current density of 30 mA/cm².

A composition and a current density of a plating bath that formed Comparative Example 4: 8.73 g/l of FeSO₄.7 H₂O, 1.4 g/l of CoSO₄.7 H₂O, 0.01 g/l of sodium benzene-sulfonic acid, 0.1 g/l of L-glutamic acid, 0 g/l of boric acid, and 0.5 g/l of sodium chloride, and a current density of 30 mmA/cm².

For each sample, a temperature of a plating bath is 30° C., a duty ratio of a pulse current is 10%, and a plating time is 30 minutes. These conditions are common to all of the following tests.

A detecting result shown in FIG. 8 shows a detecting result by Augier electron spectroscopic analysis. A detecting facility shown in FIG. 8 is JAMP-7830 F manufactured by JEOL Ltd. As an analysis condition, an acceleration voltage is 10 kV. A preset value preset by Auger electron spectroscopy analyzer was used as a sensitivity coefficient of each light element. The composition ration of FIG. 8 is a value when the summation of the composition ration of Co, Fe, N, O, C, S, Cl, and B is 100 at %.

As shown in FIG. 8, though a saturated magnetic flux density Bs of Comparative Example 1 is 2.45, which is a large value, since an acetic acid is added to a plating bath, a temporal change of a plating bath by a volatilization of the acetic acid from the plating bath is intense resulting to a poor stability and a pollution of working environment by the volatilized acetic acid. The test result of a temporal change of a plating bath used for forming the soft magnetic film of Comparative Example 1 will be described below.

As shown in FIG. 8, C is contained besides N and O in Comparative Example 2. However as shown in FIG. 8, since the content of C in Comparative Example 2 is 3.0 at %, which is large, a saturated magnetic flux density Bs is defined as a small value of 2.11.

In Comparative Example 1 and Comparative Example 2, it has been realized that a detected quantity of O increased since a boric acid and a sodium chloride is not added.

As shown in FIG. 8, in Comparative Example 3, B is contained besides N and O. Therefore a saturated magnetic flux density Bs is made of a small value of 2.28.

As shown in. FIG. 8, although only N and O are contained in Comparative Example 4, a saturated magnetic flux density Bs is defined as a small value of 2.18. It is supposed that this is due to a degradation of a saturated magnetic flux density Bs which results from a forming of an uneven crystal due to an addition of sodium chloride.

In the Example with respect to the above, as shown in FIG. 8, only N and O are contained, and moreover it has been realized that a saturated magnetic flux density Bs is made of a very large value of 2.45.

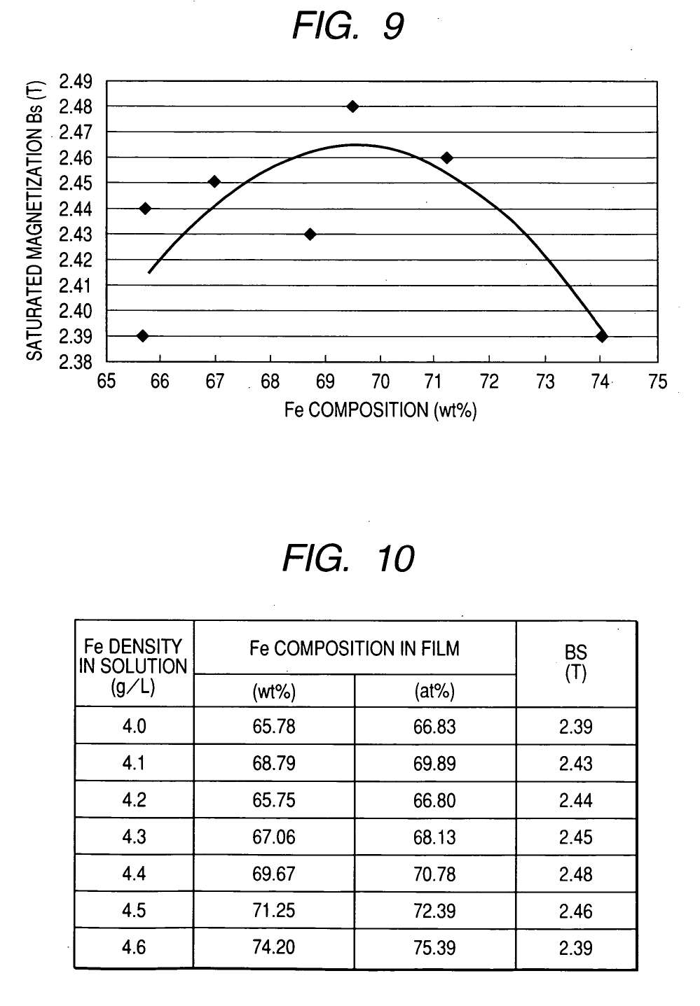

FIG. 9 is a graph that shows a relation between Fe quantity in a soft magnetic film and a saturated magnetic flux density Bs with regard to a soft magnetic film formed by using the plating bath according to the present embodiments. FIG. 10 is a table showing Fe density in a plating bath, Fe composition and a saturated magnetic flux density Bs in a soft magnetic film. In this case a quantity of L-glutamic acid added to the plating bath as a plating condition is 0.37 g/l, sodium benzene-sulfonic acid is 0.035 g/l, and a current density is 30 mA/cm². FeSo₄.7H₂O was 12.45 to 24.90 g/l and CoSO₄.7H₂O was 1.43 to 4.77 g/l. The composition ratio (wt %) of Fe was measured by the Auger electron spectroscopy analyzer (AES). The composition ratio of a total sum of adding Fe and Co is 100 wt %. The composition ratio (at %) of Fe shown in FIG. 10 is a value converted from the composition ratio (wt %) of Fe. Accordingly, the composition ratio (at %) of Fe shown in FIG. 10 is a value for a total composition ratio (100 at %) of adding Fe and Co.

As shown in FIG. 9, it has been realized that in case of plating a soft magnetic film by using the plating bath of the present embodiment, only N and O are added as impurity elements to a CoFe plating film, so that a soft magnetic film with the composition ratio of Fe from 65.5 wt % to 74 wt % and a very large Fe content rate can be plated. It has been realized that when an Fe composition ratio of a soft magnetic film formed at the plating bath according to the present embodiment is in the range from 65.5 wt % to 74 wt %, a magnetic flux BS of a soft magnetic film can be 2.39 or more. It has been realized that when an Fe composition ratio of a soft magnetic film formed at the plating bath according to the present embodiment is in the range of from 66 wt % to 73 wt %, a saturated magnetic flux density Bs can be very large as 2.42 or more.

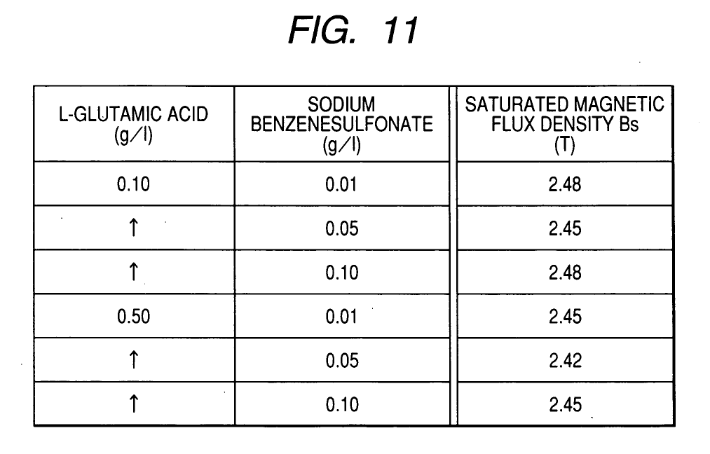

FIG. 11 is a table that shows each addition quantity of L-glutamic acid and sodium benzene-sulfonic acid added to the plating bath according to the present embodiment and a saturated magnetic flux density B.

The composition ratio of the plating bath according to the present embodiment is 12.45 g/l of FeSO₄.7 H₂O, and 1.431 g/l of CoSO₄7H₂O, and the amounts of sodium benzene-sulfonic acid and L-glutamic acid shown in FIG. 11 are added. A current density as plating condition to form a soft magnetic film was defined as 30 mA/cm². As shown in FIG. 11, it has been realized that in case of adding the L-glutamic acid in the range of 0.10 g/l to 0.50 g/l, a saturated magnetic flux density Bs can be increased from 2.42 T to 2.48 T.

As shown in FIG. 11, it has been realized that in case of adding the sodium benzene-sulfonic acid within the range from 0.01 g/l to 0.1 g/l, a saturated magnetic flux density Bs can be increased from 2.42 T to 2.48 T.

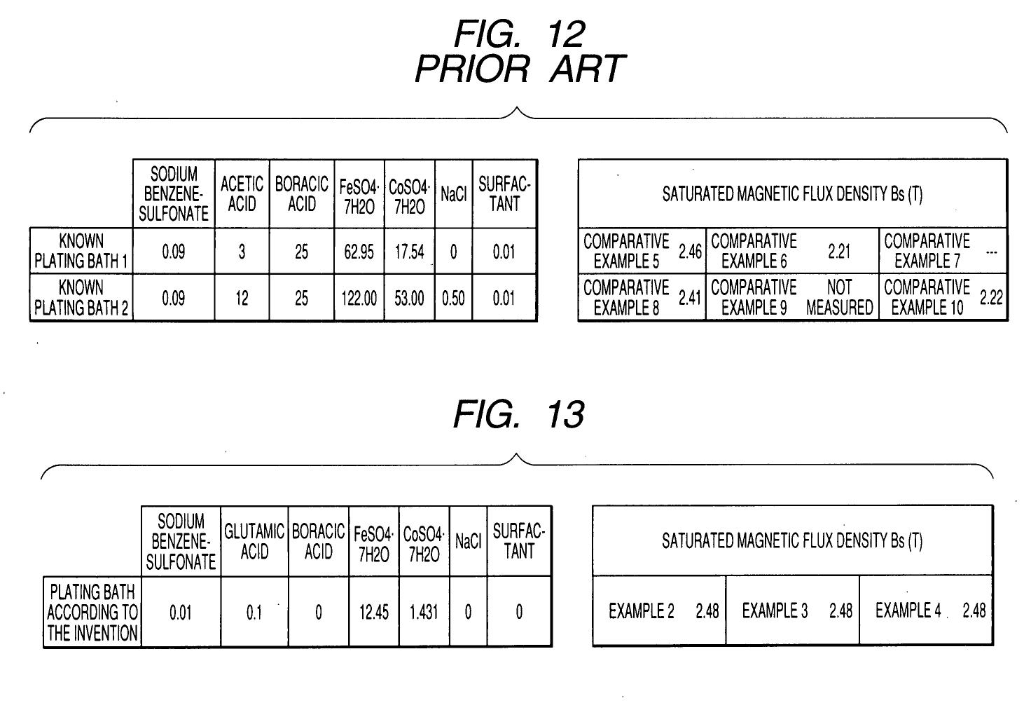

FIG. 12 is a table that shows a result of defining the soft magnetic film formed of the known plating bath as Comparative Examples 5 to 10, and measuring a saturated magnetic flux density Bs of Comparative Examples 5 to 10.

Among the tables shown in FIG. 12, the table on the left is a composition of the known plating bath. A composition of the plating bath was measured in two types of the plating bath 1 and the plating bath 2. A current density as a plating condition was 30 mA/cm².

The table shown on the right is an examination on a temporal change of a plating bath from the saturated magnetic flux densities Bs by respectively measuring the saturated magnetic flux densities Bs of, Comparative Examples 5 and 8 plated at a plating bath right after constructing bath, Comparative Examples 6 and 9 plated at a plating bath neglected for 48 hours after constructing bath, and Comparative Examples 7 and 10 formed at a plating bath after forming a soft magnetic film with thickness of 5 μm by a plating bath neglected for 48 hours after constructing bath.

Comparative Examples of 5, 6 and 7 are a soft magnetic film plated at the known plating bath 1, and Comparative Examples of 8, 9 and 10 are soft magnetic films plated at the known plating bath 2.

With regard to the plating bath 1, in case of comparing Comparative Example 5 plated at a plating bath right after constructing bath, to Comparative Example 6 plated at a plating bath neglected for 48 hours after constructing bath, a saturated magnetic flux density Bs of Comparative Example 6 plated at a plating bath neglected for 48 hours after constructing bath is smaller. And in case of comparing Comparative Example 6 plated at a plating bath neglected for 48 hours after constructing bath, to Comparative Example 7 plated at a plating bath after forming a soft magnetic film with thickness of 5 μm by a plating bath neglected for 48 hours, a saturated magnetic flux density Bs of Comparative Example 7 is so low that it can not be measured.

With regard to the plating bath 2, in case of comparing Comparative Example 8 plated at a plating bath right after constructing bath, to Comparative Example 10 plated at a plating bath after forming a soft magnetic film of 5 μm by a plating bath neglected for 48 hours, a saturated magnetic flux density Bs of Comparative Example 10 is smaller.

It has been realized that a saturated magnetic flux density Bs of a soft magnetic film by a temporal change of a plating bath is lowering in the existing bath. It is supposed that this is due to a reduction of a buffering action of a plating bath, as a volatilization of the acetic acid added to the plating bath made progress.

FIG. 13 is a table that shows the result of measuring a saturated magnetic flux density Bs of the Examples 2 to 4, by the soft magnetic film of Examples 2 and 4 plated by a composition of a plating bath of a table shown on the left of FIG. 13 (It is the same as a plating bath used when plating a soft magnetic film of the Example 1).

The table shown on the right of FIG. 13 is an examination on a temporal change of a plating bath from the saturated magnetic flux densities Bs by respectively measuring the saturated magnetic flux densities Bs of, the Example 2 plated at a plating bath right after constructing bath, the Example 3 plated at a plating bath neglected for 48 hours after constructing bath, and Comparative Example 4 plated at a plating bath after forming a soft magnetic film with thickness of 5 μm by a plating bath neglected for 48 hours after constructing bath.

As shown in FIG. 13, in case of comparing the Example 2 plated at a plating bath right after constructing bath to Example 3 plated at a plating bath neglected for 48 hours, a change (reduction tendency) of saturated magnetic flux density Bs is not shown at all. In case of comparing the Example 3 plated at a plating bath neglected for 48 hours to the Example 4 plated at a plating bath after plating a soft magnetic film of a thickness of 5 μm by a plating bath neglected for 48 hours, a change (reducing tendency) of saturated magnetic flux density Bs is not shown at all. As shown in FIG. 13 it has been realized that a temporal change of a plating bath of the present embodiments is small and the stability is very high since a change (reducing tendency) is not also shown in the Example 2 and Example 4. It is supposed that this is because it is easy to maintain a buffering action of the plating bath after a predefined time passes, as a change of a plating bath composition is very little since a material with a very high volatility such as an acetic acid is not added to a plating bath of the embodiment.

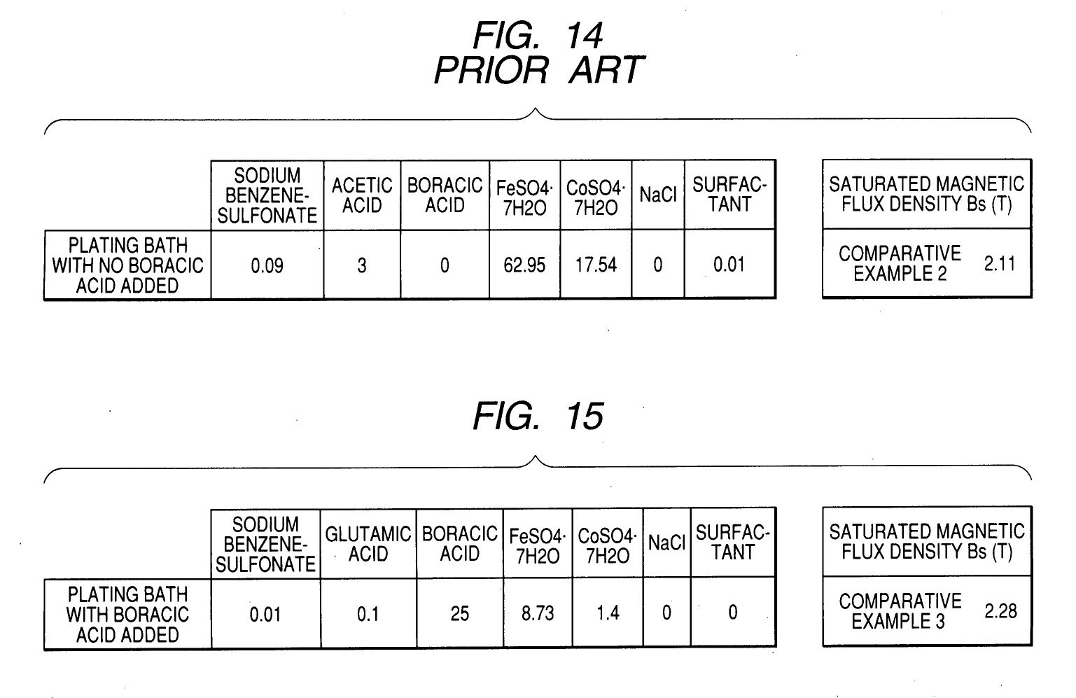

FIG. 14 is a table forming of a plating bath that does not contain a boric acid with regard to a plating bath composition of the known plating bath (plating bath with no boric acid added) to show a saturated magnetic flux density Bs of a soft magnetic film plated of the plating bath (Comparative Example shown in FIG. 8). Among the tables of FIG. 14, the table on the left shows a composition of a plating bath with no boric acid added. The table on the right shows a result of measuring a saturated magnetic flux density Bs of Comparative Example 2 plated at a plating bath with no boric acid added.

As shown in FIG. 14, in Comparative Example 2, a saturated magnetic flux density Bs is defined as a low value of 2.11. Accordingly it has been realized that in the known plating bath to which an acetic acid is added, a saturated magnetic flux density Bs can not be increased unless a boric acid is added. It is supposed that this is because a buffering action is not sufficient only with an acetic acid of pKa of 4.78, and by adding a boric acid of pKa of 9.24, a high saturated magnetic flux density Bs can be realized for the first time.

As shown in FIG. 13, it has been realized that in the plating bath according to the present embodiment even though a boric acid is not added, a saturated magnetic flux density Bs of the plated soft magnetic film (Example 2 to 4) can be increased to 2.48.

FIG. 15 is a table of adding a boric acid to the plating bath to which sodium benzenesulfonate and L-glutamic acid are added to form a plating bath (plating bath with boric acid added) to show a saturated magnetic flux density Bs of a soft magnetic film plated in the plating bath with boric acid added (Comparative example shown in FIG. 8) by).

Among the tables in FIG. 15, the table on the left shows a composition of the plating bath with boric acid added.

The table on the right shows a result of measuring a saturated magnetic flux density Bs of Comparative Example 3 formed at the plating bath with boric acid added.

As shown in FIG. 15, in Comparative Example 3, a saturated magnetic flux density Bs is defined as a low value of 2.28.

As shown in FIG. 13, it has been realized that in the plating bath with no boric acid added according to the present embodiment, a saturated magnetic flux density Bs of a plated soft magnetic film (Example 2 to 4) can be increased to 2.48.

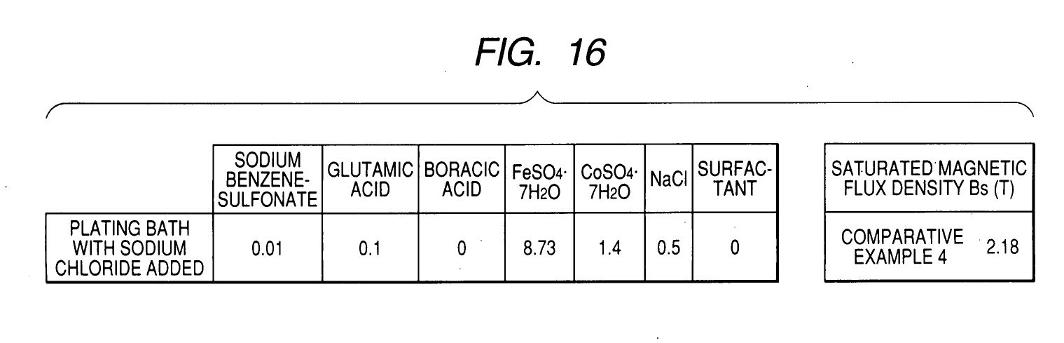

Accordingly, it has been realized that even though it is a plating bath to which not acetic acid but sodium benzenesulfonate and L-glutamic acid are added, a saturated magnetic flux density Bs decreases if a boric acid is further added. It is supposed that this is because B gets added to a plated soft magnetic film. FIG. 16 is a table of adding NaCl to the plating bath to which benzenesulfonate and L-glutamic acid are added (sodium chloride added plating bath), to show a saturated magnetic flux density Bs of a soft magnetic film plated in the following plating bath to which a sodium chloride is added (Comparative Example shown in FIG. 8).

Among the tables of FIG. 16, a table on the left shows a composition of the plating bath with sodium chloride added.

A table on the right shows a result of measuring a saturated magnetic flux density Bs of Comparative Example 4 plated in the plating bath with sodium chloride added.

As shown is FIG. 16, a saturated magnetic flux density Bs is defined as a low value of 2.18 in Comparative Example 4.

As shown in FIG. 13, it has been realized that a saturated magnetic flux density Bs of the formed soft magnetic film (Examples 2 to 4) can be increased to 2.48 in the plating bath according to the present embodiments.

Accordingly, it has been realized that even though it is a plating bath to which not acetic acid but sodium benzenesulfonate and L-glutamic acid are added, a saturated magnetic flux density Bs decreases if a sodium chloride is further added. It is supposed that this is because a saturated magnetic flux density Bs gets lower due to a formation of uneven crystal by adding a sodium chloride.

It has been realized that by forming a plating bath including only an aqueous solution of Fe salts, an aqueous solution of Co salts, sodium benzenesulfonate, and L-glutamic acid, a soft magnetic film with a high saturated magnetic flux density of 2.39 T or more, preferably 2.42 T or more can be plated since only N and o are added as impurity elements to a CoFe plating film.

By using a known plating bath 1 and plating bath 2 shown in FIG. 12, and by using a plating bath of the embodiment shown in FIG. 13, soft magnetic films were plated respectively on a substrate of a diameter of 3 inches.

The cross-sectional surface's condition from a film width direction of each soft magnetic film were observed by a focused ion beam manufacturing observation device (FIB-SIM (manufactured by SII, type SMI-98009). In a test, an accelerating voltage was 30 kV by using a Ga (gallium) ion beam.

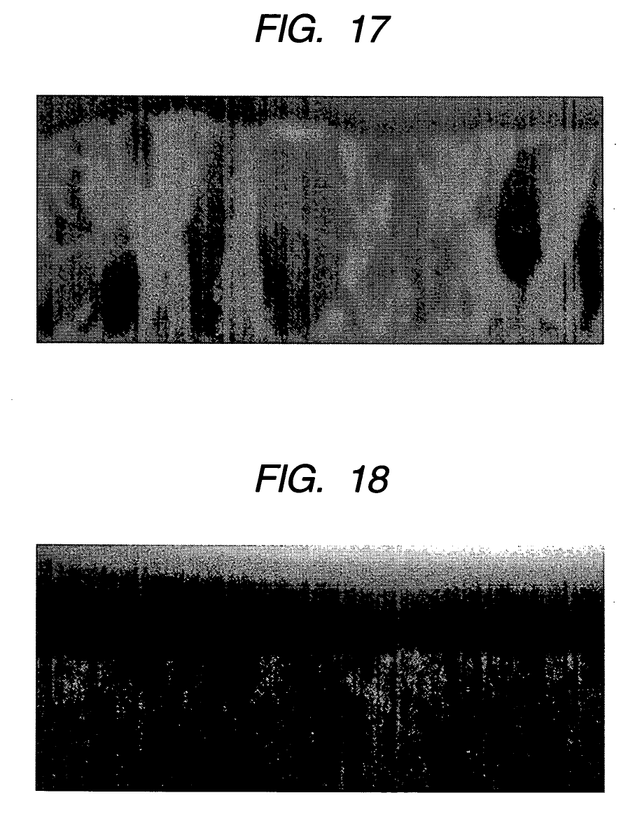

FIG. 17 is a SIM image of a soft magnetic film plated by a known plating bath 2, and FIG. 18 is a SIM image of a soft magnetic film plated by a plating bath of the embodiment.

A surface roughness Ra was measured by a contact measuring instrument, and the surface roughness Ra of any of a soft magnetic film plated by a known plating bath 1, a soft magnetic film plated by a known plating bath 2 and a soft magnetic film plated by the embodiment was in the range of 9 to 11A which did not show much change. As described above, it is regarded that there being not much change in the surface roughness Ra of the soft magnetic films plated by the plating bath of the embodiment and also by the known plating bath is due to a measurement of a surface roughness of a soft magnetic film formed over a broad range of a substrate with a diameter of 3 inches and an error of a measurement. However, since a formation area of a recording head plating the soft magnetic film is a very narrow space, a condition of a soft magnetic film plated in such narrow space was measured in the second place.

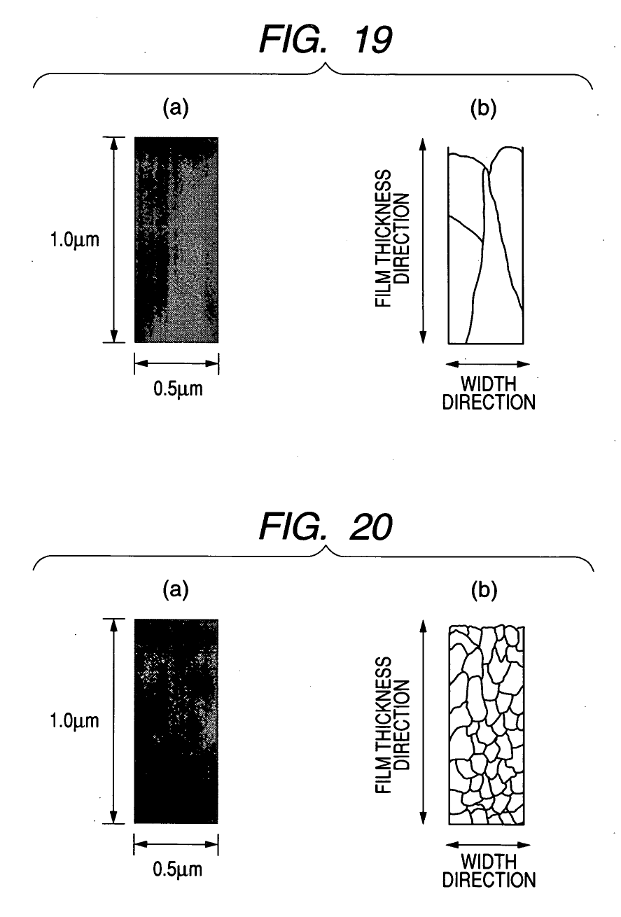

FIG. 19(a) is a SIM image of observing a condition of a section of the soft magnetic film at a focused ion beam manufacturing observation device (FIB-SIM (manufactured by SII) type SMI-98009) by plating a soft magnetic film using the known plating bath 2 in a narrow space of a width of 0.5 μm and a height of 1.0 μm. FIG. 19(b) is a schematic view of FIG. 19(a).

FIG. 20(a) is a SIM image of observing a condition of a section of the soft magnetic film at a focused ion beam manufacturing observation device (FIB-SIM (manufactured by SII) type SMI-98009) by plating a soft magnetic film using the plating bath composition of the embodiment in a narrow space of a width of 0.5 μm and a height of 1.0 μm. FIG. 20(b) is a schematic view of FIG. 20 (a).

As shown in FIG. 19, it has been realized that a crystal of a soft magnetic film plated by a known plating bath 2 became a columnar crystal in a film width direction. In particular, in a narrow space of a width of 0.5 μm and a height of 1.0 μm, it has been realized that since a columnar crystal which penetrates from a lower surface to an upper surface is formed, it is not minutely crystallized and a surface of the soft magnetic film becomes a very large irregular shape.

As shown in FIG. 20, it has been realized that a surface of the soft magnetic film is close to a flattening surface compared to FIG. 19 since a crystal of a soft magnetic film formed by a plating bath of the embodiment was minutely crystallized and in a narrow space of 0.5 μm and a height of 1.0 μm, and since it became a minute film structure in which a plurality of crystals exist whichever part it was in a film width direction as viewed in a width direction due to a plurality of crystals existing any portion in a width direction as viewed in a film width direction.

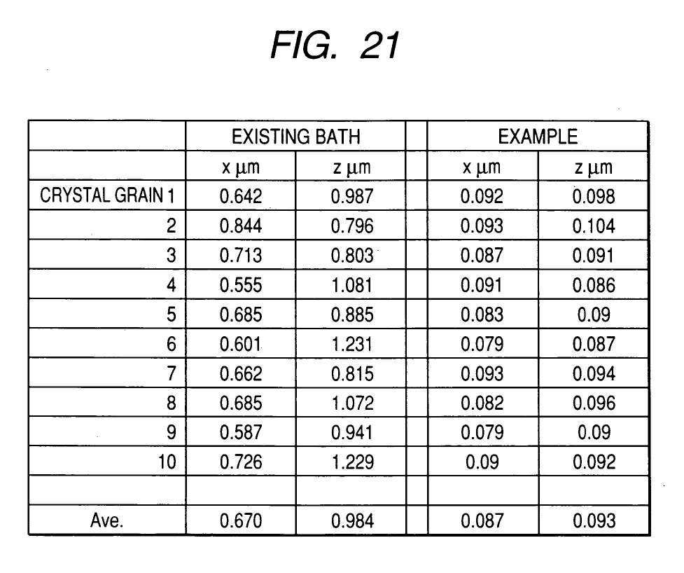

The average crystal grain diameter of the soft magnetic films of FIG. 19 and FIG. 20 were obtained by an average of each length size, randomly selecting 10 crystal grains shown on a SIM image surface to respectively measure a length size in a track width direction (X direction) and a length size in a height direction (Z direction). The result is shown in FIG. 21. As shown in FIG. 21 and measured, an average crystal grain diameter of a soft magnetic film in a known example of FIG. 19 is 0.1 μm or more, and an average crystal grain diameter of a soft magnetic film in an embodiment of FIG. 20 is 0.1 μm or less.

When 10 or more crystal grains are not shown on a SIM image surface, an average crystal grain diameter is obtained by conducting the measurement for the entire crystal grains shown on a SIM image surface.

What is claimed is:

1. A soft magnetic film having a saturated magnetic flux density Bs of at least 2.39 T, in which only N and O are added as impurity elements to a CoFe plating film.

2. The soft magnetic film according to claim 1, wherein the composition ratio of N is in the range of about 0 at % to 4.2 at % when the total composition ratio of Co, Fe, N, and O is 100 at %.

3. The soft magnetic film according to claim 1, wherein the composition ratio of O is in the range of about 0 at % to 10.8 at % when the total composition ratio of Co, Fe, N, and O is 100 at %.

4. A soft magnetic film, in which only N and O are added as impurity elements to a CoFe plating film, the composition ratio of N is in the range of about 0 at % to 4.2 at %, and the composition ratio of O is in the range of 0 at % to 10.8 at %, when the total composition ratio of Co, Fe, N, and O is 100 at %.

5. The soft magnetic film according to claim 1, wherein an average crystal grain diameter is 0.1 μm or less.

6. The soft magnetic film according to claim 4, wherein an average crystal grain diameter is 0.1 μm or less.

7. The soft magnetic film according to claim 1, wherein the composition ratio of Fe is in the range of 65.5 wt % to 74 wt % when the total composition ratio of Co and Fe is 100 at %.

8. The soft magnetic film according to claim 4, wherein the composition ratio of Fe is in the range of about 65.5 wt % to 74 wt % when the total composition ratio of Co and Fe is 100 at %.

9. The soft magnetic film according to claim 7, wherein the composition ratio of Fe is in the range of about 66 wt % to 73 wt %.

10. The soft magnetic film according to claim 8, wherein the composition ratio of Fe is in the range of about 66 wt % to 73 wt %.

11. A recording head of a longitudinal magnetic recording, the recording head comprising a lower core layer, an upper core layer, and a magnetic pole portion disposed between the lower core layer and the upper core layer to restrict a track width on a surface facing a recording medium,
wherein the magnetic pole portion includes a lower magnetic pole layer connected to the lower core layer, an upper magnetic layer connected to the upper core layer, and a gap layer located between the lower magnetic pole layer and the upper magnetic pole layer, or the magnetic pole layer includes an upper magnetic pole layer connected to the upper core layer and a gap layer located between the upper magnetic pole layer and the lower core layer, and
wherein the upper magnetic pole layer, the lower magnetic pole layer, or the upper magnetic pole layer and the lower magnetic pole layer are plated with a soft magnetic film.

12. The recording head according to claim 11, wherein the soft magnetic film comprises a saturated magnetic flux density Bs of at least 2.39 T, in which only N and O are added as impurity elements to a CoFe plating film.

13. The recording head according to claim 12, wherein the track width is in the range of about 0.05 to 0.5 μm, the thickness of the upper magnetic pole layer is in the range of about 0.1 to 5.0 μm, the thickness of the lower magnetic pole layer is in the range of about 0.1 to 5.0 μm,
the lower magnetic pole layer, the upper magnetic pole layer, or the upper magnetic pole layer and the lower magnetic pole layer have a plurality of crystals, in any portion of the track width, as viewed in the thickness direction.

14. A recording head of a perpendicular magnetic recording, the recording head including a main magnetic pole layer, wherein a track width is restricted by a surface of the main magnetic pole layer facing a recording medium and the main magnetic pole layer is plated with a soft magnetic film.

15. The recording head according to claim 14, wherein the soft magnetic film comprises a saturated magnetic flux density Bs of at least 2.39 T, in which only N and O are added as impurity elements to a CoFe plating film.

16. The recording head according to claim 15, wherein the track width is in the range of about 0.1 to 1.0 μm, the thickness of the main magnetic pole layer is in the range of about 0.1 to 2.0 μm, and the main magnetic pole layer has a plurality of crystals in any portion of the track width as viewed in the thickness direction.

17. The recording head according to claim 13 wherein a plurality of crystals exist on any portion in the thickness direction as viewed in the track width direction.

18. The recording head according to claim 16, wherein a plurality of crystals exist on any portion in the thickness direction as viewed in the track width direction.

19. A method of manufacturing a soft magnetic film, wherein only N and O are added as impurity elements to a CoFe plating film by using a plating bath including only an aqueous solution of Fe salts, an aqueous solution of Co salts, sodium benzenesulfonate, and L-glutamic acid.

20. The method according to claim 19, wherein the sodium benzenesulfonate added to the plating bath is in the range of 0.01 g/l to 0.10 g/l.

21. The method according to claim 19, wherein the L-glutamic acid added to the plating bath is in the range of 0.1 g/l to 0.5 g/l.

22. A recording head of an longitudinal magnetic recording, the recording head comprising a lower core layer, an upper core layer, and a magnetic pole portion which is disposed between the lower core layer and the upper core layer to restrict a track width on a surface that faces a recording medium,
wherein the magnetic pole portion is formed of a lower magnetic pole layer connected to the lower core layer, an upper magnetic layer connected to the upper core layer and a gap layer located between the lower magnetic pole layer and the upper magnetic pole layer, or the magnetic pole layer formed of an upper magnetic pole layer connected to the upper core layer, and a gap layer located between the upper magnetic pole layer and the lower core layer, and
wherein the upper magnetic pole layer, the lower magnetic pole layer, or the upper magnetic pole layer and the lower magnetic pole layer are plated with a soft magnetic film.

23. The recording head according to claim 22, wherein the soft magnetic film comprises only N and O added as impurity elements to a CoFe plating film by using a plating bath including only an aqueous solution of Fe salts, an aqueous solution of Co salts, sodium benzenesulfonate, and L-glutamic acid.

24. The method according to claim 23, wherein in plating the magnetic pole portion, a frame having a narrow space for plating the magnetic pole portion is formed on the facing surface and in the narrow space, the track width is restricted to the range of about 0.05 to 0.5 μm, the thickness of the upper magnetic pole layer is restricted to the range of about 0.1 to 5.0 μm, and the thickness of the lower magnetic pole layer is restricted to the range of about 0.1 to 5.0 μm, and
wherein the upper magnetic pole layer, the lower magnetic pole layer, or the upper magnetic pole layer and the lower magnetic pole layer are plated in the narrow space using the plating bath, in which a plurality of crystals having a fine crystal structure with an average crystal grain diameter of about 1 μm or less exist in any portion of the track width as viewed in the width direction.

25. A method of manufacturing a perpendicular magnetic recording head, the recording head including a main magnetic pole layer restricting a track width to a surface facing a recording medium,
wherein the main magnetic pole layer is plated with a soft magnetic film.

26. The method according to claim 25, wherein in plating the magnetic pole portion, a frame having a narrow space for plating the magnetic pole portion is formed on the facing surface and in the narrow space, the track width is restricted to the range of about 0.05 to 0.5 μm, the thickness of the upper magnetic pole layer is restricted to the range of about 0.1 to 5.0 μm, and the thickness of the lower magnetic pole layer is restricted to the range of about 0.1 to 5.0 μm, and
wherein the upper magnetic pole layer, the lower magnetic pole layer, or the upper magnetic pole layer and the lower magnetic pole layer are plated in the narrow space using the plating bath, in which a plurality of crystals having a fine crystal structure with an average crystal grain diameter of about 1 μm or less exist in any portion of the track width as viewed in the width direction.

27. The method according to claim 26, wherein in plating the main magnetic pole layer, a frame having a narrow space for plating the main magnetic pole layer is formed on the facing surface and in the narrow space, the track width is restricted to the range of about 0.1 to 1.0 μm and the thickness of the main magnetic pole layer is restricted to the range of about 0.1 to 2.0 μm, and
wherein the main magnetic pole layer is plated in the narrow space using the plating bath, in which a plurality of crystals having a fine crystal structure with an average crystal grain diameter of about 1 μm or less exist in any portion of the track width Tw as viewed in the width direction.

28. The method according to claim 23, wherein the lower magnetic pole layer, the upper magnetic pole layer, or the main magnetic pole layer plated with the soft magnetic film has a plurality of crystals in any portion in the thickness direction as viewed in the track width Tw direction.

29. A longitudinal magnetic recording head comprising a lower core layer, an upper core layer, and a magnetic pole portion which is disposed between the lower core layer and the upper core layer to restrict a track width on a surface facing a recording medium,
wherein the magnetic pole portion includes a lower magnetic pole layer connected to the lower core layer, an upper magnetic layer connected to the upper core layer, and a gap layer located between the lower magnetic pole layer and the upper magnetic pole layer, or the magnetic pole layer includes an upper magnetic pole layer connected to the upper core layer and a gap layer located between the upper magnetic pole layer and the lower core layer, and
wherein the upper magnetic pole layer, the lower magnetic pole layer, or the upper magnetic pole layer and the lower magnetic pole layer are plated with a soft magnetic film.

30. The longitudinal magnetic recording head according to claim 29, wherein the soft magnetic film includes only N and O added as impurity elements to a CoFe plating film, the composition ratio of N is in the range of about 0 at % to 4.2 at %, and the composition ratio of O is in the range of 0 at % to 10.8 at %, when the total composition ratio of Co, Fe, N, and O is 100 at %.

31. The recording head according to claim 30, wherein the track width is in the range of about 0.05 to 0.5 μm, the thickness of the upper magnetic pole layer is in the range of about 0.1 to 5.0 μm, the thickness of the lower magnetic pole layer is in the range of about 0.1 to 5.0 μm,
the lower magnetic pole layer, the upper magnetic pole layer, or the upper magnetic pole layer and the lower magnetic pole layer have a plurality of crystals in a portion of the track width Tw, as viewed in the thickness direction.

32. A perpendicular magnetic recording head comprising a main magnetic pole layer, wherein a track width is restricted by a surface of the main magnetic pole layer facing a recording medium and the main magnetic pole layer is plated with a soft magnetic film.

33. The perpendicular magnetic recording head according to claim 32, wherein the soft magnetic film comprises only N and O added as impurity elements to a CoFe plating film, the composition ratio of N is in the range of about 0 at % to 4.2 at %, and the composition ratio of O is in the range of 0 at % to 10.8 at %, when the total composition ratio of Co, Fe, N, and O is 100 at %.

34. The recording head according to claim 33, wherein the track width is in the range of about 0.1 to 1.0 μm, the thickness of the main magnetic pole layer is in the range of about 0.1 to 2.0 μm, and the main magnetic pole layer has a plurality of crystals in a portion of the track width as viewed in the thickness direction.

35. The recording head according to claim 31 wherein a plurality of crystals exist on a portion in the thickness direction as viewed in the track width direction.

36. The recording head according to claim 34 wherein a plurality of crystals exist on a portion in the thickness direction as viewed in the track width direction.
